(19) United States
(12) Patent Application Publication
(10) Pub. No.: US 2026/0024992 A1
(43) Pub. Date: Jan. 22, 2026

(54) TIME DEFERRED POWER UTILIZATION

(71) Applicant: Paul N. KATZ, Houston, TX (US)

(72) Inventor: Paul N. KATZ, Houston, TX (US)

(21) Appl. No.: 19/170,575

(22) Filed: Apr. 4, 2025

Related U.S. Application Data
(60) Provisional application No. 63/674,033, filed on Jul. 22, 2024.

(51) Int. Cl. H02J 3/00; G06Q 50/06; G21B 3/00; H01M 10/44; H02J 3/32; H02J 9/06

(52) U.S. Cl. CPC H02J 3/001; G06Q 50/06; G21B 3/00; H01M 10/441; H02J 3/32; H02J 9/062

(57) ABSTRACT

Backup electric power with a batter(ies) storing electrical energy (kilowatt hours—KWH) and a DC-to-AC inverter converting the stored electrical energy from the battery into electrical AC power (kilowatts—KW) may be provided for emergency power used when power from the electric utility fails. Condominium units and apartments in high rise buildings can benefit from having DC-to-AC inverter battery systems installed in each unit. Spare capacity power from existing emergency backup generators may be utilized to charge the battery of the inverter battery system of each condominium/apartment unit. The DC-to-AC inverter battery system may be used to reduce ampacity requirements of the electric utility power distribution system and electric service entrance equipment coupled to the utility electric meter per occupancy. Cold fusion-low energy nuclear reaction (LENR) power generation, may be used in place of or partial substitution of power from the electric utility.

### TECHNICAL FIELD

Embodiments of the present disclosure generally relate to electric power systems, and in particular, to electric power systems providing time deferred power utilization.

### BACKGROUND

Electric power systems have become essential to the existence of modern standards of living. Electric power systems provide electricity for operation of lighting, cooling, heating, transportation, communications, manufacturing, etc.; all taken for granted today but essential to life as we know it. Without electricity society would have to revert back to horse drawn transportation, oil lamp lighting, burning wood for cooking and heating, and steam and hydroelectric power to run the machines for manufacturing.

Normally today's electricity is supplied by electrical generation plants using natural gas, coal, atomic energy, photovoltaic panels, wind turbines and/or hydro (dams) power. The electricity generated by these plants may be distributed over electrical transmission lines and substations to customer electrical service equipment. The electrical service equipment may then distribute the electricity to equipment, lighting, heating and cooling in buildings of industrial plants, businesses and residential occupancies. When the electrical generation plants and electrical distribution equipment are operating properly the modern world functions smoothly.

However, if there is an interruption at any point in the operation of the electrical generation and/or distribution equipment then the convenience and comforts of the electrical 21^{st} century are lost. Backup point of use engine generators may be installed and used to temporarily provide electrical power to replace the absence of the normally provided electrical power from the electrical generation and distribution equipment of an electric utility.

The backup engine generators may be fueled with gasoline, diesel, propane, and/or natural gas. Natural gas may be available from a natural gas distribution network. The other liquid fuels would have to be stored in fuel tanks adjacent to the engine generator. Engine generator power output sizing must be sufficient to supply enough power to start electric motors, such as, but not limited to, an air conditioner condensing compressor, a dishwasher, a pool pump, an elevator lift motor, etc. When the motor is not starting (peak load) or running, the electric load will be much less. But the engine generator must still be sized to have enough power output that is sufficient to run a worst-case load. Thus, the full power capacity of an engine generator is infrequently used.

More recent technology solar and wind electric generation may be stored in batteries and converted to AC power for homes and businesses. But solar and wind electric generation require large areas for the solar panels and/or wind turbines. Engine generators also require a certain amount of space to meet fire codes, e.g., NFPA 37, and have to be located outside or vented to the outside because of engine combustion carbon monoxide exhaust gases.

### SUMMARY

In one example of the disclosure, a system for providing time deferred electric power, includes a storage battery, a direct current (DC) to alternating current (AC) inverter having a direct current input coupled to the storage battery and an alternating current output adapted for coupling to electrical loads, and a charging device having an output coupled to the storage battery and an input coupled to a power source.

In one example of the disclosure, a system for providing time deferred electric power to a plurality of electrical services having electrical loads coupled thereto, includes a plurality of storage batteries, a plurality of direct current (DC) to alternating current (AC) inverters, each having a direct current input coupled to a respective at least one of the plurality of storage batteries and an alternating current output adapted for coupling to electrical loads; and a plurality of charging devices each having an output coupled to respective ones of the storage batteries and an input coupled to a power source.

### BRIEF DESCRIPTION OF THE DRAWINGS

So that the manner in which the above recited features of the present invention can be understood in detail, a more particular description of the invention, briefly summarized above, may be had by reference to examples, some of which are illustrated in the appended drawings. It is to be noted, however, that the appended drawings illustrate only typical examples of this invention and are therefore not to be considered limiting of its scope, for the invention may admit to other equally effective examples.

FIG. 1 illustrates a representative prior art schematic block diagram layout of a backup engine generator and transfer switch coupled to an existing electric service panel supplying electrical power to a residence or business.

FIG. 2 illustrates a representative prior art schematic block diagram layout of a backup solar panel, battery and DC-to-AC inverter system and transfer switch coupled to an existing electric service panel supplying electrical power to a residence or business.

FIG. 3 illustrates a representative schematic block diagram layout of a transfer switch, service panel, electrical loads, DC-to-AC inverter, battery, and battery charging controller representative of each unit, according to an example.

FIG. 4 illustrates a representative schematic block diagram layout of a transfer switch, service panel, electrical loads, DC-to-AC inverter, battery, battery charging controller and power source, according to an example.

FIG. 5 illustrates a representative schematic block diagram layout of a service panel, electrical loads, DC-to-AC inverter, battery, and battery charging controller, according to an example.

To facilitate understanding, identical reference numerals have been used, where possible, to designate identical elements that are common to the figures, and a lower-case letter added where the elements are substantially the same. It is contemplated that elements of one embodiment may be beneficially incorporated in other embodiments.

### DETAILED DESCRIPTION

Various features are described hereinafter with reference to the drawing figures. It should be noted that the drawing figures may or may not be drawn to scale and that the elements of similar structures or functions are represented by like reference numerals throughout the drawing figures. It should be noted that the drawing figures are only intended to facilitate the description of the features of the examples. They are not intended as an exhaustive description of the examples below or as a limitation on the scope of the claims. In addition, an illustrated example need not have all the aspects or advantages shown. An aspect or an advantage described in conjunction with a particular example is not necessarily limited to that example and can be practiced in any other examples even if not so illustrated, or if not so explicitly described. Referring now to the drawing figures, the details of examples are representative layouts schematically illustrated. Like elements in the drawing figures will be represented by like numbers, and similar elements will be represented by like numbers with a different lower-case letter suffix.

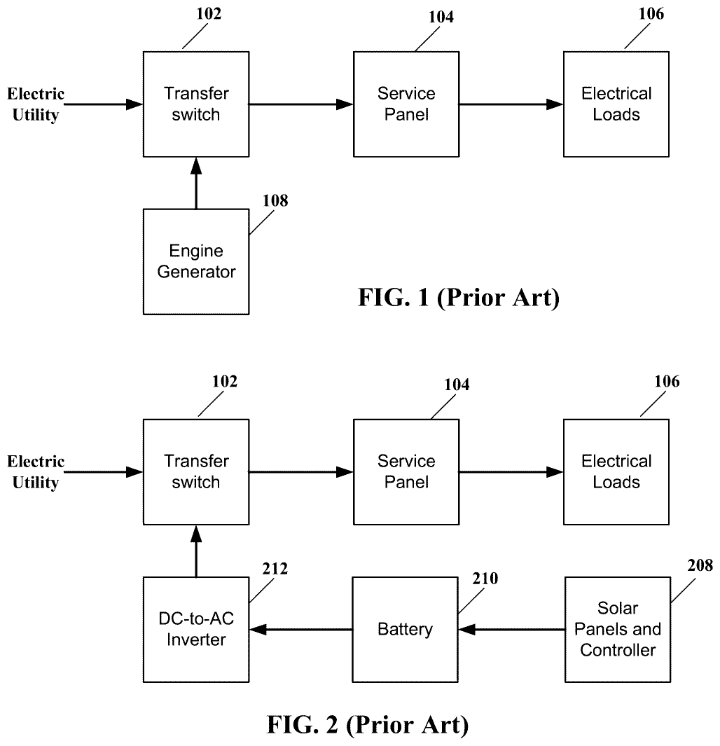

Referring to FIG. 1, depicted is a representative prior art schematic block diagram layout of a backup engine generator and transfer switch coupled to an existing electric utility service panel supplying electrical power to a residence or business. An engine generator 108 is provided to supply sufficient peak power to the electrical loads 106 through the transfer switch 102 and service panel 104 when the transfer switch 102 couples the engine generator 108 to service panel 104. When the engine generator 108 is not required (utility power available) then the transfer switch 102 couples the service panel 104 to the electric utility.

The engine generator requires enough outdoor space to meet the NFPA 37 requirements and fuel storage or a natural gas connection. The engine generator has a high decibel running noise level and its output power capacity must be sized sufficiently to provide enough power for motor starting loads. The engine generator also requires period maintenance, oil changes and operational testing (engine-generator servicing).

Referring to FIG. 2, depicted is a representative prior art schematic block diagram layout of a backup solar panel, battery and DC-to-AC inverter system, and transfer switch coupled to an existing electric service panel supplying electrical power to a residence or business. A battery 210 and DC-to-AC inverter 212 are provided to supply sufficient peak power to the electrical loads 106 through the transfer switch 102 and service panel 104 when the transfer switch 102 couples the DC-to-AC inverter 212 to the service panel 104. When the battery 210 and DC-to-AC inverter 212 are not required (utility power available) then the transfer switch 102 couples the service panel 104 to the electric utility.

Quite a few residences and businesses do not have sufficient space required to install an engine generator, solar panels and/or wind turbines. According to the teachings of this disclosure, these residences and businesses may be supplied with backup electric power with a batter(ies) storing electrical energy (kilowatt hours—KWH) and a DC-to-AC inverter converting the stored electrical energy from the battery into electrical AC power (kilowatts—KW). A battery and DC-to-AC inverter system may be dedicated to and located at each occupancy, e.g., residence or business.

The DC-to-AC inverter may be configured to provide the necessary electric power (KW) for starting and running all connected motor, heating, appliance and lighting loads. A sufficiently sized battery may be provided for the needed KWH which is the integral of the KW loads over time. Sizing of the DC-to-AC inverter KW output capacity and battery energy storage KWH may be easily determined by historical electrical usage from power company bills.

Various KW output capacity DC-to-AC inverters are readily available, as are DC storage batteries. A number of companies provide DC-to-AC inverter and electric storage battery systems that may be integrated into a residence or business electrical distribution system (service breaker panel). For example, EcoFlow Technology Inc., makes such systems in many different KW and KWH capacities.

While the DC-to-AC inverter battery systems are readily available, a problem exists as to how to maintain an energy charge (KWH) on the battery over an extended period of time. When the electric power grid is operational, charging of the battery is easy. And when the electric power grid is not available for short periods of time, having sufficient battery energy storage capacity (KWH) may be sufficient without further concern. However, when the electric power grid is not available for extended periods of time, the cost of batteries and space required to maintain the availability of power may be exorbitant.

### Condominiums and Apartments

Condominium units and apartments in high rise buildings can benefit from having DC-to-AC inverter battery systems installed in each unit, and, according to the teachings of this disclosure, spare capacity power from existing emergency backup generators may be utilized to trickle charge the battery of the inverter battery system of each condominium/apartment unit. The high-rise building emergency generator output power (KW) capacity must be sized sufficiently to run elevator motors, cooling tower pumps, AC chillers, emergency lighting and other intermittent equipment loads. When any of these intermittent equipment loads are not in use the emergency backup generator will have spare output power capacity available for charging of the condominium/apartment unit batteries. In newer high-rise buildings or retrofit emergency backup generator installations, charging of individual condominium/apartment unit batteries may be included in sizing of a high-rise building emergency generator system.

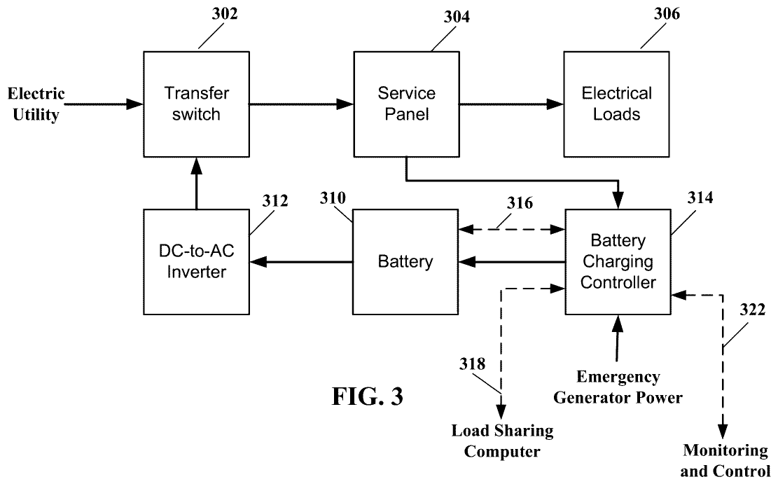

Referring to FIG. 3, depicted is a representative schematic block diagram layout of a transfer switch 302, service panel 304, electrical loads 306, DC-to-AC inverter 312, battery 310, and battery charging controller 314 representative of each unit. When utility power is available, the transfer switch 302 couples the utility power to the service panel 304 which supplies electrical power to the electrical loads 306, and can be used to charge the battery 310 through the battery charging controller 314. When utility power is not available, the transfer switch 302 couples the AC output of the DC-to-AC inverter 312 to the service panel 304 which supplies electrical power to the electrical loads 306. The DC-to-AC inverter 312 may be a plurality of DC-to-AC inverters 312 coupled to respective ones of a plurality of batteries 310. The AC outputs of the plurality of DC-to-AC inverters 312 may be coupled together for supplying increased power to higher demand electrical loads 306.

A load control computer (not shown) may be coupled to the battery charging controller 314. The load control computer may use the battery charging controller 314 to control the amount of charging current to the battery 310. This allows for dynamic load balancing and emergency generator output sharing when charging the battery 310 of each condominium/apartment unit. Effectively utilizing the full output power (KW) available from the building emergency generator system at all times. Charging rates of the condominium/apartment unit batteries 310 may fluctuate over time, but if the energy (KWH) used in charging the battery 310 (from the building emergency generator) is substantially equal to the energy usage (KWH) of the condominium/apartment unit, then long power outages may be effectively accommodated without requiring excessive battery capacity in each condominium/apartment unit.

A communications circuit 316 may be implemented so that the battery 310 will not be overcharged by the battery charging controller 314. The battery charging controller 314 may also be put into standby (no charging power) until the battery 310 drops below a certain charge level (control signal over the communications circuit 316). The battery charging controller 314 may be configured so that battery charging starts when the charge on the battery 310 falls below a first value, e.g., 40 percent, and continues to charge the battery 310 until a second value, e.g., 95 percent, is reached. This will further free up charging power (from the building emergency generator) available to charge batteries 310 when they are at or below the certain or first charge levels. This may provide for random charging diversity as a supplement and/or backup to the load sharing computer control.

Furthermore, a data link 322 to each unit may be implemented for monitoring and control of the battery charging load controller 314 for occupancy power use billing purposes, and dynamic charging control. The data link 322 to each unit provides control and communications in a “power user group hive” that may be dynamically “fine-tuned” to maintain a constant load on the emergency power generator source.

The high-rise building emergency generator may be fueled by a natural gas supply network or a large diesel storage tank. Billing information of KWHs used to charge each condominium/apartment unit may also be provided by the battery charging controller 314 units coupled to the computer load sharing control system. Artificial intelligence (AI) may be used in the battery charging control units computer load sharing control program to optimize allocations of KW outputs of each battery charging controller314 based on KWH usage of each condominium/apartment unit. Each battery charging controller 314 may be in communications 318 with the computer running the load sharing control program and/or external monitoring and control 322, using either wired or wireless communications technologies, such as for example, but not limited to, Ethernet, Wi-Fi, Zigbee, LoRa and the like.

Stores in shopping centers may also benefit from having DC-to-AC inverter battery systems that are connected for charging to a central emergency general system(s) of the shopping center. Similar control for charging the store DC-to-AC inverter battery systems may be used as described above for condominium and apartment units.

### Individual Dwelling Units and Businesses

Individual houses and town houses may benefit from having DC-to-AC inverter battery systems for emergency power backup. Charging of the battery thereof may be with solar panels, wind turbines, and/or small engine generator sets fueled by gasoline, diesel, propane, and/or natural gas. Present technology emergency power backup systems require a large engine generator to handle peak inrush currents necessary for starting motors, e.g., air conditioning (AC) compressors, pool pumps, dish washers, laundry washing machines, etc.

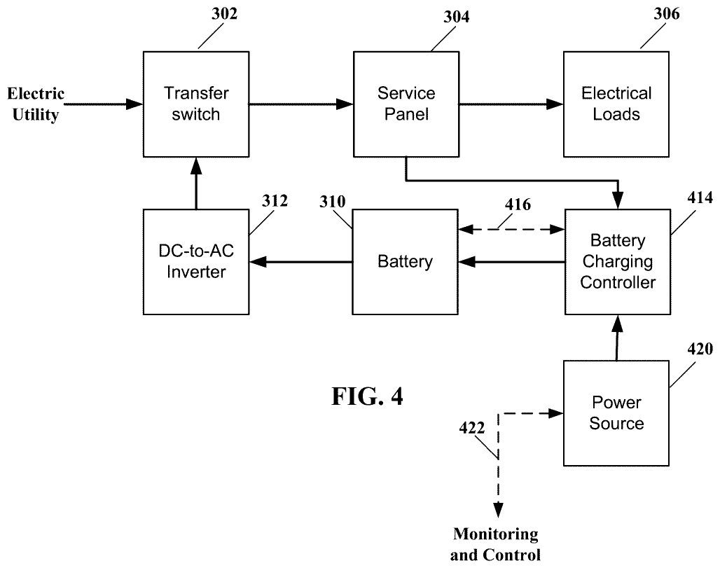

Referring to FIG. 4, depicted is a representative schematic block diagram layout of a transfer switch 302, service panel 304, electrical loads 306, DC-to-AC inverter 312, battery 310, and battery charging controller 414. By using a DC-to-AC inverter battery system 310, 312 there is no longer a peak power (KW) demand requirement of the AC power source. A kilowatt (power) is equal to voltage times current. Voltage is constant but current varies with KW demand. Instead, a constant battery charging KW demand results by using the DC-to-AC inverter battery system 310, 312 to provide for peak power demands of the connected AC loads 306. For example, the average KWH (energy) over 24 hours may be 100 KWH. Energy (KWH) is the integral of power (KW) over time, where power demand may be large for brief periods of time, e.g., starting motors. The DC-to-AC inverter battery system 310, 312 can provide those brief large power demands from the stored energy (KWH) in its battery 310. Recharging the battery requires lower instantaneous power (KW) when done over time. From the example above of using 100 KWH over 24 hours results in an average charging rate to recharge the battery of 100/24 or 4.17 KW per hour. This may easily be provided by a 5 KW engine generator, running at 84 percent capacity, and used to recharge the battery over time. Therefore, instead of requiring a 25 KW output engine generator necessary for handling large motor starting currents a lower current output power source 420 may be utilized to charge the battery 310 over time at a constant power. This power source 420 may be an inexpensive, lightweight, compact, and low noise engine generator that may provide charging power to the battery 310 for long term emergency power needs. The power source 420 may also be put into standby-off (no charging power) until the battery 310 drops below a certain charge level (control signal over the communications circuit 416). This will provide for cooling down time, servicing and refueling (when necessary) of the smaller engine generator (power source 420). The DC-to-AC inverter 312 may be a plurality of DC-to-AC inverters 312 coupled to respective ones of a plurality of batteries 310. The AC outputs of the plurality of DC-to-AC inverters 312 may be coupled together for supplying increased power to higher demand loads 306.

Solar and/or wind may also be used to supplement battery charging but those two energy sources are intermittent at best and require a lot of space. However, future power source technologies are being developed, such as for example but not limited to, cold fusion-low energy nuclear reaction (LENR) which may be able to supplement and/or replace connection to a power utility. LENR power generation used for the power source 420 need only supply enough power over time to maintain the required KWH usage of the connected electrical loads. The battery 310 and DC-to-AC inverter 312 can provide the necessary peak demand power (current) for starting motors and other short-term high-power demand loads.

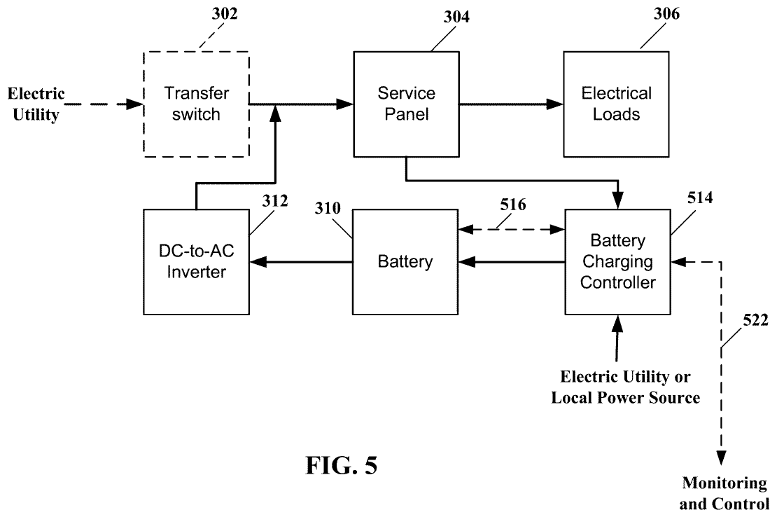

The DC-to-AC inverter battery system is not just for emergency backup power when the utility power is not available. It may be used to reduce ampacity requirements of the electric utility power distribution system and electric service entrance equipment coupled to the utility electric meter. Referring to FIG. 5, depicted is a representative schematic block diagram layout of a service panel 304, electrical loads 306, DC-to-AC inverter 312, battery 310, and battery charging controller 514. Presently, the electric utility power distribution system and individual service panels must be sized for maximum instantaneous power required by the loads. The electric utility voltage is constant, e.g., 240/120 volts AC (alternating current), so the amperage of the connected loads will vary, greatly when a motor starts. This requires that the wire ampacity of the electric utility power distribution system and individual service panels must be sized accordingly. There are diversity factors that may be applied for electrical conductor ampacity requirements, but the full ampacity capabilities of electrical conductors are not used at all times, thus excess ampacity must be figured into the design of the electrical distribution equipment so as to handle peak current (power) load requirements.

If peak power demand can be supplied from the DC-to-AC inverter battery system 310, 312 to the customer service panel 304 (owner occupancy electrical distribution system), and a battery charging controller 514 connected to the utility service meter and set for a constant power (current) demand to charge the DC-to-AC inverter battery system 310, 312, then the electric utility service conductor ampacities could be reduced with a subsequent increase in electric utility power availability with no increase in the utility power conductor ampacity. Thus, by using a DC-to-AC inverter battery system 310, 312 to provide time deferred power utilization at each electric power customer's location, the power company can provide increased available power capacity without having to increase the electrical distribution infrastructure, e.g., transmission lines, substations and generators. Making available monitoring and control 522 of each power user battery controller 514 allows transparent load sheading and electrical network load balancing so as to utilize the electrical utility distribution system most efficiently.

The power source (electric utility or local power) may also be disconnected until the battery 310 drops below a certain charge level (control signal over the communications circuit 516. A large enough in number “power user group hive” whose power use can be “collectively” controlled gives the power utility more flexibility in running and maintaining the power distribution system. Controlling power demand in the power user group hive would go unnoticed to the user/customers as the stored energy in the respective batteries 310 will supply power during brief utility power reductions (brownouts) or even shutoff (blackouts).

The DC-to-AC inverter battery system may also be configured to provide clean, filtered AC power to customers' sensitive electronic loads, isolated from power surges and transients inherent on the power company transmission lines. In jurisdictions where the power company charges a premium for large peak power demand, then leaving the DC-to-AC inverter battery system connected during normal operation will save money on the electric bill, and only switching out if there is a failure in the DC-to-AC inverter battery system (e.g., using transfer switch 302). It is contemplated and within the scope of this disclosure that future technology local power sources, e.g., cold fusion-low energy nuclear reaction (LENR) power generation, may be used in place of the electric utility power connection.

As will be appreciated by one skilled in the art and having the benefit of this disclosure, the examples disclosed herein may be embodied as a system, method, apparatus, or computer programmed product. Accordingly, aspects may take the form of an entirely hardware embodiment, an entirely software embodiment (including firmware, resident software, micro-code, etc.) or an example embodiment combining software and hardware aspects that may all generally be referred to herein as a “circuit,” “module” or “system.” Furthermore, aspects may take the form of a computer program product embodied in one or more computer readable medium(s) having computer readable program code embodied thereon.

While the foregoing is directed to example embodiments of the present invention, other and further example embodiments of the invention may be devised without departing from the basic scope thereof, and the scope thereof is determined by the claims that follow.

What is claimed:

1. A system for providing time deferred electric power, comprising:
a storage battery;
a direct current (DC) to alternating current (AC) inverter having a direct current input coupled to the storage battery and an alternating current output adapted for coupling to electrical loads; and
a battery charging controller having an output coupled to the storage battery and an input coupled to a power source.

2. The system according to claim 1, wherein the storage battery stores electrical energy to be supplied to the DC-to-AC inverter for conversion to AC power.

3. The system according to claim 1, wherein the battery charging controller is adapted to draw substantially constant power from the power source when charging the storage battery.

4. The system according to claim 3, wherein the constant power draw of the battery charging controller is adjustable.

5. The system according to claim 1, wherein the power draw of the battery charging controller is metered for billing purposes.

6. The system according to claim 4, wherein the battery charging controller is monitored and controlled by a monitoring and control system.

7. The system according to claim 6, wherein the monitoring and control system dynamically adjusts the power draw of the battery charging controller.

8. The system according to claim 1, wherein the storage battery is a plurality of storage batteries.

9. The system according to claim 1, wherein the DC-to-AC inverter is a plurality of DC-to-AC inverters.

10. The system according to claim 1, wherein the plurality of DC-to-AC inverters have the AC outputs thereof coupled together and the AC power is load shared therebetween.

11. The system according to claim 1, wherein the battery charging controller disconnects from the power source when the battery is above a certain charge level.

12. The system according to claim 1, wherein the battery charging controller will start charging the battery when the battery is at or below a first charge level and stop charging the battery when the battery is at or above a second charge level.

13. The system according to claim 1, wherein the power source is low energy nuclear reaction (LENR) power generation.

14. A system for providing time deferred electric power to a plurality of electrical services having electrical loads coupled thereto, comprising:
a plurality of storage batteries;
a plurality of direct current (DC) to alternating current (AC) inverters, each having a direct current input coupled to a respective at least one of the plurality of storage batteries and an alternating current output adapted for coupling to electrical loads; and
a plurality of battery charging controllers each having an output coupled to respective ones of the storage batteries and an input coupled to a power source.

15. The system according to claim 14, wherein each of the plurality of battery charging controllers is adapted to draw substantially constant power from the power source when charging a respective at least one of plurality of storage batteries.

16. The system according to claim 15, wherein the constant power draw of each of the plurality battery charging controllers is adjustable.

17. The system according to claim 14, wherein the power draw of each of the plurality of battery charging controllers is metered for billing purposes.

18. The system according to claim 16, wherein the plurality of battery charging controllers are monitored and controlled by a monitoring and control system.

19. The system according to claim 18, wherein the monitoring and control system dynamically adjusts the power draw of each of the plurality of battery charging controllers.

20. The system according to claim 19, wherein the monitoring and control system monitors other electrical loads coupled to the power source and adjusts the power draw of each of the plurality of battery charging controllers so that the total power draw from the power source remains substantially constant.

21. The system according to claim 20, wherein the monitoring and control system uses artificial intelligence (AI) to optimize the power draw of each of the plurality of battery charging controllers in relation to the power draw of the other electrical loads coupled to the power source.

22. The system according to claim 14, wherein selected ones of the plurality of battery charging controllers disconnect from the power source when respective ones of the plurality of storage batteries are above a certain charge level.

23. The system according to claim 14, wherein the battery charging controller will start charging the battery when the battery is at or below a first charge level and stop charging the battery when the battery is at or above a second charge level.

24. The system according to claim 14, wherein the power source is low energy nuclear reaction (LENR) power generation.
